(19) United States
(12) Patent Application Publication
(10) Pub. No.: US 2009/0262386 A1
(43) Pub. Date: Oct. 22, 2009

(54) SYSTEMS AND METHODS FOR REUSING PROCESSED DATA IN AN IMAGING DEVICE

(75) Inventors: Andrew Rodney Ferlitsch, Camas, WA (US); Roy Kenneth Chrisop, Camas, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/107,632

(22) Filed: Apr. 22, 2008

(51) Int. Cl. G06F 3/12

(52) U.S. Cl. 358/1.15

(57) ABSTRACT

A method for reusing data in an imaging device is described. An imaging job is received at an imaging device. The imaging job includes file system information and a document in a first format. It is determined whether the document has been previously processed by the imaging device. The document is processed if it was determined that the document had not been previously processed by the imaging device. The processing provides a processed document in a second format. The processed document is saved if it was determined that the document had not been previously processed by the imaging device. A previously saved processed document is reused that corresponds to the document if it was determined that the document had been previously processed by the imaging device.

### TECHNICAL FIELD

The present disclosure relates generally to computers, imaging devices and computer-related technology. More specifically, the present disclosure relates to reusing processed data in an imaging device.

### BACKGROUND

“Imaging,” as the term is used herein, refers to one or more of the processes involved in the display and/or printing of graphics and/or text. The term “imaging device,” as used herein, refers to any electronic device that provides functionality related to imaging. Some examples of imaging devices include multi-function peripheral devices, printers, copiers, scanners, facsimile devices, document servers, image servers, electronic whiteboards, digital cameras, digital projection systems, medical imaging devices, and so forth.

For various reasons, an imaging device may be logically connected to (i.e., placed in electronic communication with) one or more computer systems, which may be referred to as host computer systems (or simply as hosts). For example, a printer may be connected to a network of computer systems. This allows the users of the various computer systems on the network to use the printer.

Different kinds of computer software facilitate the use of imaging devices. The computer system that is used to image (e.g., print) the materials typically has one or more pieces of software that enable it to send information to the imaging device to facilitate the imaging of the materials. If the computer system is on a computer network there may be one or more pieces of software running on one or more computers on the computer network that facilitate the imaging of the materials.

As used herein, the term “imaging job” may refer to an imaging-related task that is performed by an imaging device. An example of an imaging job is a print job, which may be a single document or a set of documents that is submitted to a printer for printing. Imaging jobs such as copying, scanning, and the like may be referred to as walkup imaging jobs (or simply as walkup jobs).

In certain computing environments, it may be desirable to increase the efficiency of imaging and imaging jobs. Benefits may be realized if systems and methods were provided that improved the efficiency of using imaging devices. The present disclosure relates to systems and methods for reusing processed data in an imaging device.

### BRIEF DESCRIPTION OF THE DRAWINGS

FIG. 1 is a block diagram illustrating a system for reusing processed data in an imaging device in accordance with one configuration;

FIG. 2 is a block diagram illustrating a job package being directly submitted to an imaging device;

FIGS. 3a and 3b illustrate a configuration when a multi-function peripheral (MFP) supports a job auditing function that keeps a thinned (reduced) copy of the document in its original format for subsequent reuse;

FIGS. 4a and 4b illustrate a configuration when the MFP supports a filing function that keeps a copy of the rasterized data for some period of time for subsequent reuse (e.g., reprint);

FIGS. 5a and 5b illustrate a configuration when the MFP supports a format translation function that keeps a copy of the translated data for some period of time for subsequent reuse (e.g., reprint);

FIG. 6 is a block diagram illustrating the major hardware components typically utilized with embodiments herein;

FIG. 7 is a network block diagram illustrating one possible environment in which the present systems and methods may be implemented; and

FIG. 8 illustrates one configuration of a method for reusing processed data in an imaging device.

### DETAILED DESCRIPTION

Traditionally, a document in its original format (e.g., Microsoft Word format) is first converted into printer ready data using a format specific application and a multi-function peripheral (MFP) specific printer driver. The printer ready data is then sent to the MFP, which is then rasterized into engine ready data. The engine ready data is then sent to the output engine for outputting (e.g., printing). In this method, the data is translated first on a host and then rasterized on the MFP. The translated/rasterized data is then discarded after a single use. Thus, if the document is subsequently printed again, the document has to be fully re-translated and re-rasterized again.

Some of the more modern MFPs now have the ability to perform the translation step as well as the rasterization step on a limited number of formats. This may be done in a variety of ways, such as having a translator built into a chip, running an application under a guest operating system, or using an external translator. In this method, the data is both translated and then rasterized on the MFP. The translated/rasterized data is then discarded after a single use. Thus, if the document is subsequently printed again, the document has to be fully re-translated and re-rasterized again.

One improvement to the above is to use the filing capability of an MFP. In this case, the user may instruct the MFP to save a copy of the rasterized data for some period of time. The saved rasterized data may then be used for reprinting. Additionally, the MFP may perform other tasks with either the original document or rasterized data, such as creating a thin copy for a job audit record. But this method still has some drawbacks. For example, the user has to explicitly indicate to save the rasterized data. The device may not necessarily allow a remote reuse (i.e., print from PC) vs. a walkup reuse. Additionally, other users printing the same document may not be aware of the stored data.

The present systems and methods detect and reuse previously translated and/or rasterized data when a document is printed more than once. Such systems and methods improve the efficiency of the use of the MFP and may help in reducing the total cost of ownership (TCO) of MFP devices.

A method for reusing data in an imaging device is described. An imaging job is received at an imaging device. The imaging job includes file system information and a document in a first format. It is determined whether the document has been previously processed by the imaging device. The document is processed if it was determined that the document had not been previously processed by the imaging device. The processing provides a processed document in a second format. The processed document is saved if it was determined that the document had not been previously processed by the imaging device. A previously saved processed document is reused that corresponds to the document if it was determined that the document had been previously processed by the imaging device.

In one configuration processing the document may comprise translating the document, and the second format may comprise printer ready data. Processing the document may also include rasterizing the document, and the second format may comprise engine ready data. Additionally, processing the document may include thinning the document, and the second format may comprise a thinned document.

Determining may include comparing the file system information with saved file system information. The file system information may include a pathname, a file size, a modification date and an author. The file system information may further include a checksum and a universally unique identifier (UUID).

The imaging device may include different kinds of imaging devices, including a multi-function peripheral. The imaging job may include a print job. The imaging job may further include job settings.

In one aspect the first format may not be printer ready data such that the document was sent to the imaging device using a direct submit utility. Processing the document may comprise translating the document, and the second format may comprise printer ready data. Additionally second processing may be performed, wherein the second processing may comprise rasterizing the printer ready data into engine ready data.

In one configuration saving may further comprise saving the file system information with the processed document. Determining may be accomplished automatically and without user input regarding determining whether the document has been previously processed by the imaging device.

An imaging device that is configured for reusing data is also described. The imaging device includes a processor and memory in electronic communication with the processor. Instructions may be stored in the memory. An imaging job is received at an imaging device. The imaging job includes file system information and a document in a first format. It is determined whether the document has been previously processed by the imaging device. The document is processed if it was determined that the document had not been previously processed by the imaging device. The processing provides a processed document in a second format. The processed document is saved if it was determined that the document had not been previously processed by the imaging device. A previously saved processed document is reused that corresponds to the document if it was determined that the document had been previously processed by the imaging device.

A computer-readable medium comprising executable instructions is also described. An imaging job is received at an imaging device. The imaging job includes file system information and a document in a first format. It is determined whether the document has been previously processed by the imaging device. The document is processed if it was determined that the document had not been previously processed by the imaging device. The processing provides a processed document in a second format. The processed document is saved if it was determined that the document had not been previously processed by the imaging device. A previously saved processed document is reused that corresponds to the document if it was determined that the document had been previously processed by the imaging device.

Several exemplary embodiments are now described with reference to the Figures. This detailed description of several exemplary embodiments, as illustrated in the Figures, is not intended to limit the scope of the claims.

The word “exemplary” is used exclusively herein to mean “serving as an example, instance or illustration.” Any embodiment described as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments,” unless expressly specified otherwise.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The present systems and methods improve the efficiency of an imaging device, such as an MFP, and lower the total cost of ownership by reusing previously translated and/or rasterized data, when a document is subsequently reprinted. The present systems and methods also disclose novel ways of determining that the same document is to be reprinted, without requiring binary comparison of the document or rasterized contents.

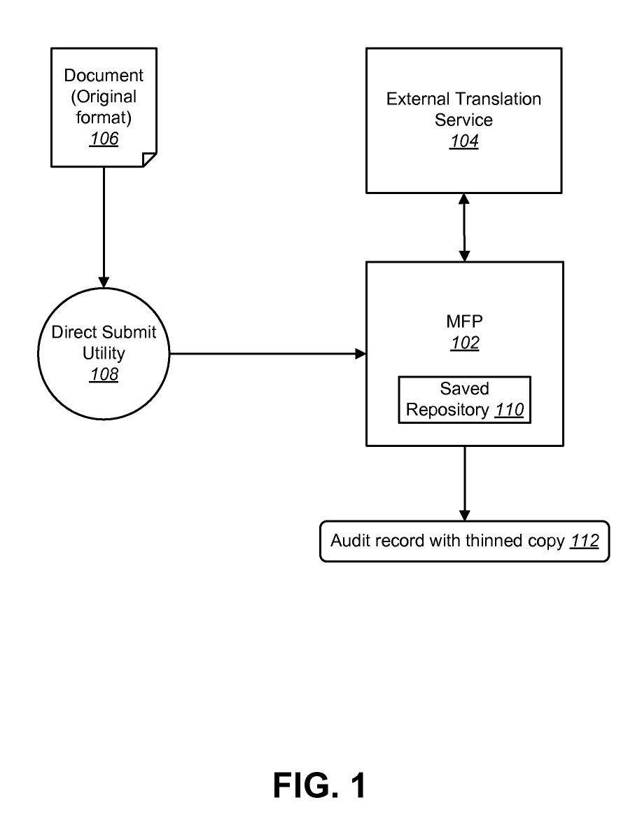

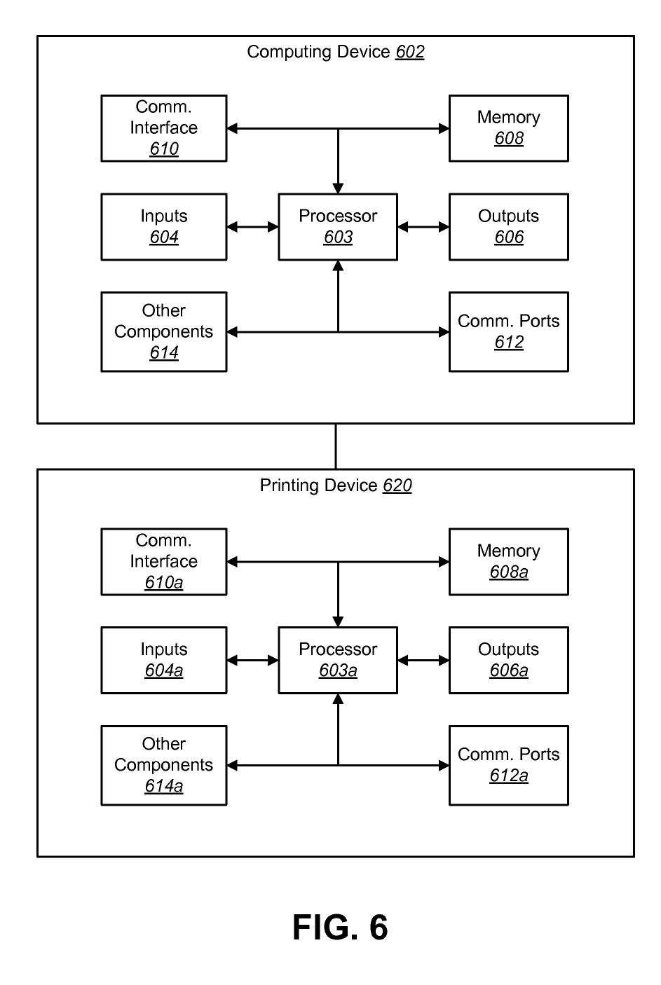

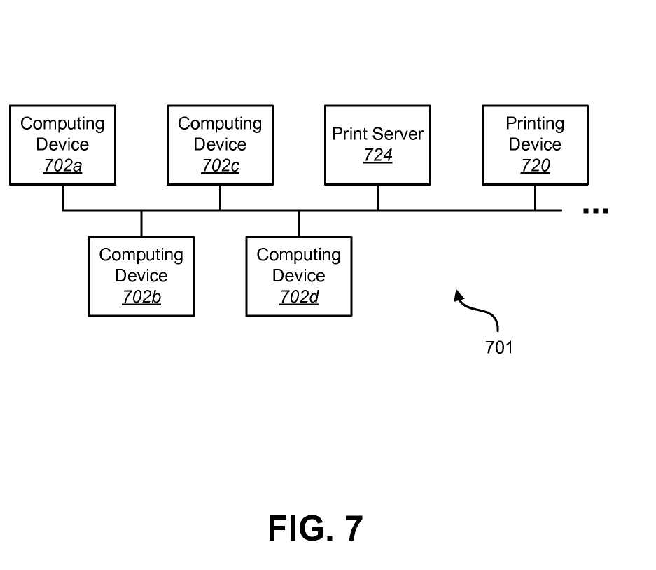

FIG. 1 is a block diagram illustrating a system for reusing processed data in an imaging device in accordance with one configuration. The exemplary operating environment includes one or more printer or MFP devices 102. Additionally, one or more hosts capable of initiating a job on the MFP 102 are in electronic communication with the one or more MFPs 102. (Illustrated in FIGS. 6 and 7.)

The MFP 102 may support the direct submission of one or more application formats (e.g., Microsoft Word), which are non-native to the MFP 102. In this case, the MFP 102 may use an external translation service 104 to convert the original document format 106 into a format native to the MFP 102.

In the configuration shown in FIG. 1, a document 106 is submitted via a direct submit application or utility 108 (DSA) directly to an MFP 102 without conversion into printer ready data (i.e., driverless). In addition to sending the document contents AS-IS, along with job setting information, the DSA 108 additionally sends file system information about the document, such as: full pathname of the document, file size, creation and last modification date.

The MFP 102 (and/or external service) upon processing (e.g., rasterization, translation, auditing, etc) may save the rasterized, translated, and/or thinned copy of the document for some period of time. Additionally, the file system information of the original document is saved with the saved data.

When the MFP 102 receives subsequent job requests, it first determines if the ‘same’ document had been previously processed. It does this by querying the saved repository 110 data store and passing the file system information of the new document request. The saved repository 110 then determines if there is a match (e.g., translated data, raster data, thinned document audit data, etc). If so, the MFP 102 and/or external services 104 may skip the processing step and reuse the saved data.

By reusing the saved data, the MFP 102 becomes more efficient in being able to use less processing power and output faster on documents which are frequently processed. The less use of translation/rasterization services may also reduce per job costs. Additionally, reuse of thinned document data in an audit trail may reduce the amount of needed storage.

Through the above and other reductions realized, an owner or leaser of the MFP 102 may realize a reduction in the total cost of ownership (TCO).

The exemplary operating environment includes one or more imaging devices (printers and/or MFP devices 102). The printer/MFP 102 may perform one or more imaging functions, such as, but not limited to, print, copy, scan, fax, file, publish and/or conversion.

The devices may optionally be in electronic communication with one or more external services that may perform one or more functions for the MFP. Example services include format translation, rasterization and auditing.

As mentioned earlier, a document 106 may be passed to the printer/MFP 102 for processing in its original format (i.e., driverless) through the use of a direct submit application 108 (DSA). If the document format is not native to the printer 102 (i.e., printer ready data specific to the printer model), the printer/MFP 102 may then use an internal, hosted or external translation service 104 to convert the document data into a format native to the printer/MFP 102.

Additionally, the printer/MFP 102 may support a job auditing function, where a thinned (reduced) copy of the original document is stored with the audit record 112.

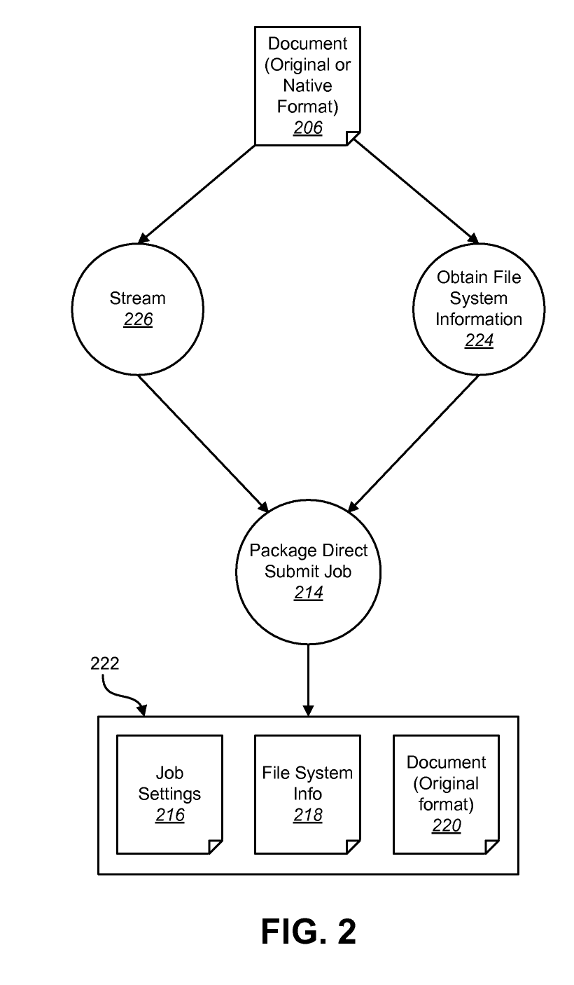

FIG. 2 is a block diagram illustrating a job package 222 being directly submitted to an imaging device. In one configuration, a user may directly submit (i.e., driverless) a document 206 in its original format to an MFP 102 through a direct submit application 108 (DSA). The DSA 108 then packages 214 the document into a job that is passed to the MFP 102.

The DSA 108 may also collect additionally information about the job from the user and/or other sources, such as job settings 216. The job settings 216 may be collected via an interactive user interface (UI) or obtained from a set of default or active settings in a host side repository (e.g., system registry).

The supported job settings 216 may be determined by the DSA 108 in any manner, such as a generic set predefined in the DSA 108, a model specific set predefined in the DSA 108, and/or dynamically determined by querying the device or proxy acting on behalf of the device.

Additionally, the DSA 108 queries the operating system to obtain 224 file system information 218 relating to the document 206 that is to be submitted to the MFP 102. The information 218 is used to uniquely identify the document 206 and also to determine if it has subsequently changed. The file system information 218 may include the full pathname of the document, the file size of the document, the creation date, the modification date and the author.

The DSA 108 may use a stream 226 to obtain a file in some cases. For example, if the file is located on a remote host, it is possible that the file may be streamed 226 to the DSA 108 in order to create the job package 222.

The DSA 108 may also derive other identifying information about the document and its contents, such as a checksum of the entire or subset of the document contents. The DSA 108 then packages 214 the job 222 that corresponds to the processing to be performed on the document. The job package 222 may include document contents 220 or a Uniform Resource Identifier (URI) address to the document, job settings 216 and file system information 218 and any related derived identifying information. The package 222 may be in any format, such as, but not limited to, an XML format, a binary encoding, or any other proprietary format.

An MFP 102 may be configured to receive and process imaging jobs. The job package 222 may be one kind of imaging job. Processing an imaging job (a broader term than the job package 222) may involve performing one or more imaging operations on an electronic document. Alternatively, or in addition, processing an imaging job may involve performing one or more imaging operations on a hardcopy document (not shown). Some examples of imaging operations include printing, copying, scanning, filing, faxing, emailing, performing format conversion, publishing, duplicating, displaying, performing optical character recognition (OCR), performing Bates stamping, bar code-related operations, storage, image enhancement, compression, encryption, watermarks, indexing/filing, document transfer, natural language translation, etc.

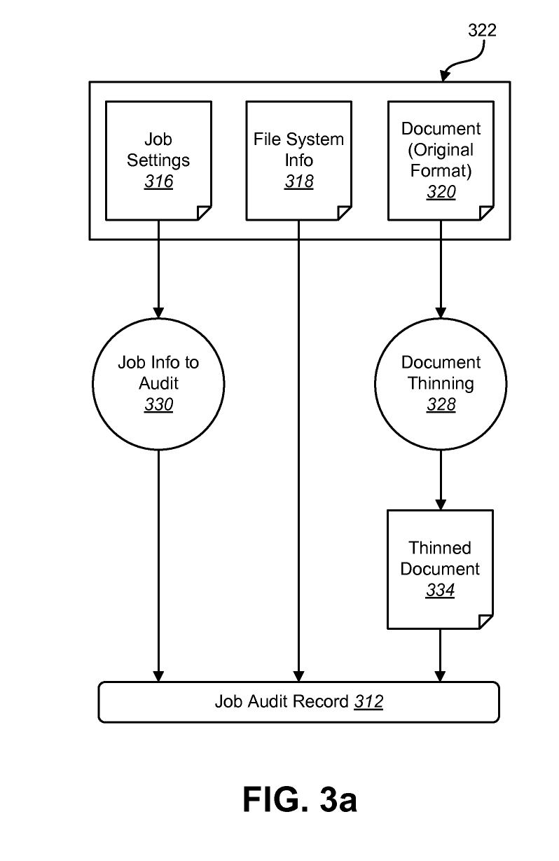

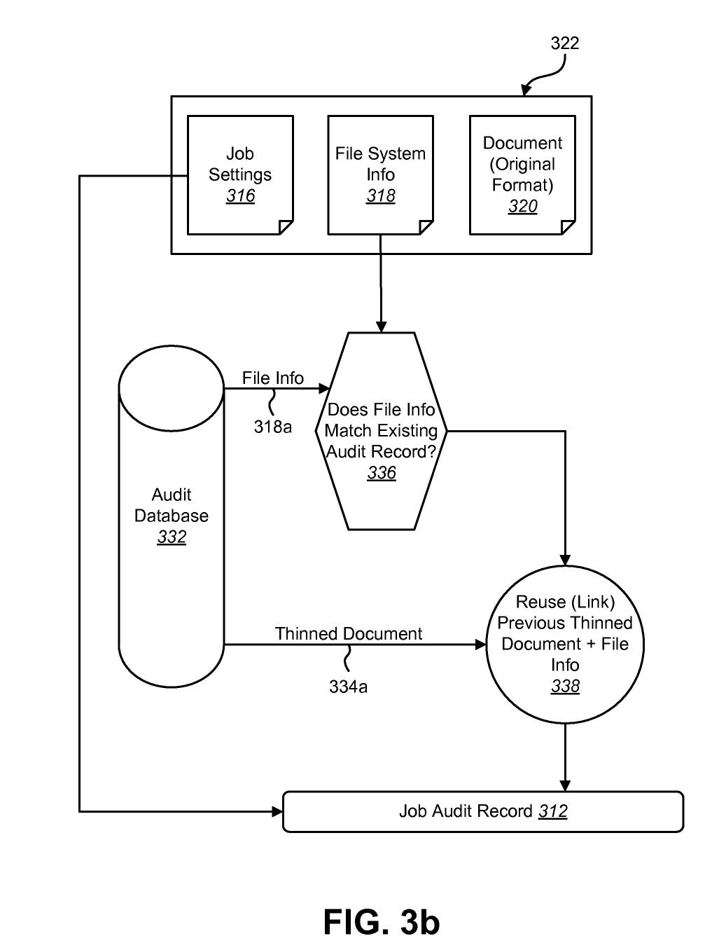

FIGS. 3a and 3b describe a configuration when the MFP 102 supports a job auditing function that keeps a thinned (reduced) copy 334 of the document in its original format. FIG. 3a illustrates when a job audit is performed for the first time.

When the MFP 102 receives a document for the first time, the MFP 102 may perform the following steps relating to a job audit with a thinned copy 334 of the original document 320. The MFP 102 may create 328 a thinned (reduced) copy 334 of the original document 320 that is stored as part of the audit record 312. (See U.S. patent application Ser. No. 11/565,220, entitled “Job Auditing Systems and Methods for Direct Imaging of Documents”, filed on Nov. 30, 2006, which is incorporated herein by reference.)

The audit record 312 may store additional information 330 about the job 322, such as the entire or subset of the job settings 316. The audit record 312 may store additional information about the source of the job 322, such as the submitters name or the host IP address. Additionally, the audit record 312 may store the file system information 318 associated with the document 320.

FIG. 3b illustrates a subsequent audit (an audit performed after the audit illustrated in FIG. 3a). When the MFP 102 subsequently receives documents, the MFP 102 first attempts to determine 336 if the document has been seen before and if so, whether the contents of the document are unchanged. The MFP 102 may determine 336 this by a comparison of the file system information 318 in the job 322 with the file system information 318a stored in the audit record repository 332. Below are examples of how a match may be made.

A match may be found when the full pathname, creation date, last modification date and file size are identical. Additionally, a match may be found when the document name (without the directory path), file size and checksum are identical. Additionally, a match may be found when a universally unique identifier (UUID) embedded in the documents (without matching document names), file size and checksum are identical. This may be useful when different individuals have separate copies of the same document, such as when a document (e.g., training material) is sent to a group of individuals. Other tests may also be used to determine whether the documents are identical.

If the MFP 102 determines 336 that the document has been processed before, without changes to content, the MFP 102 may perform the same audit function as described above, with the following exceptions:

1. The MFP 102 may skip the step of creating a thinned copy of the document.

2. The MFP 102 may use 338 a link (or optional copy of) to the previously stored thinned copy 334a.

3. The previously stored (matching) thinned document 334a may maintain a link count. If the associated previous audit record is deleted and the link count is not zero, the thinned document data is preserved until the link count is zero.

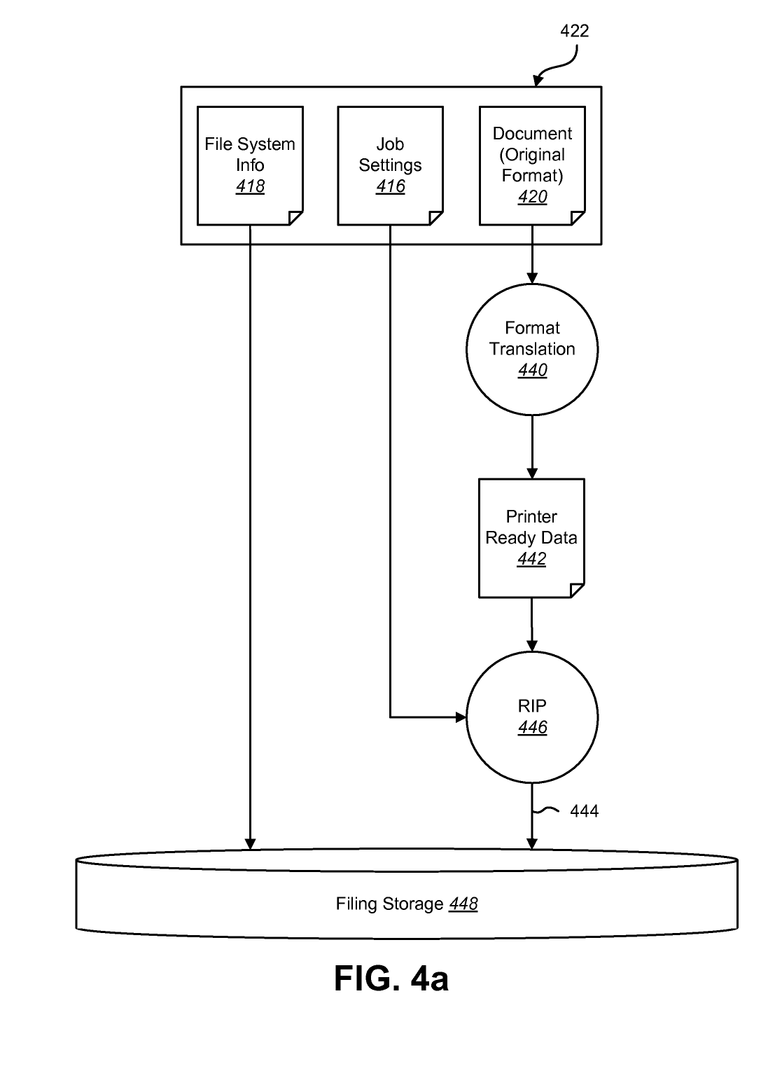

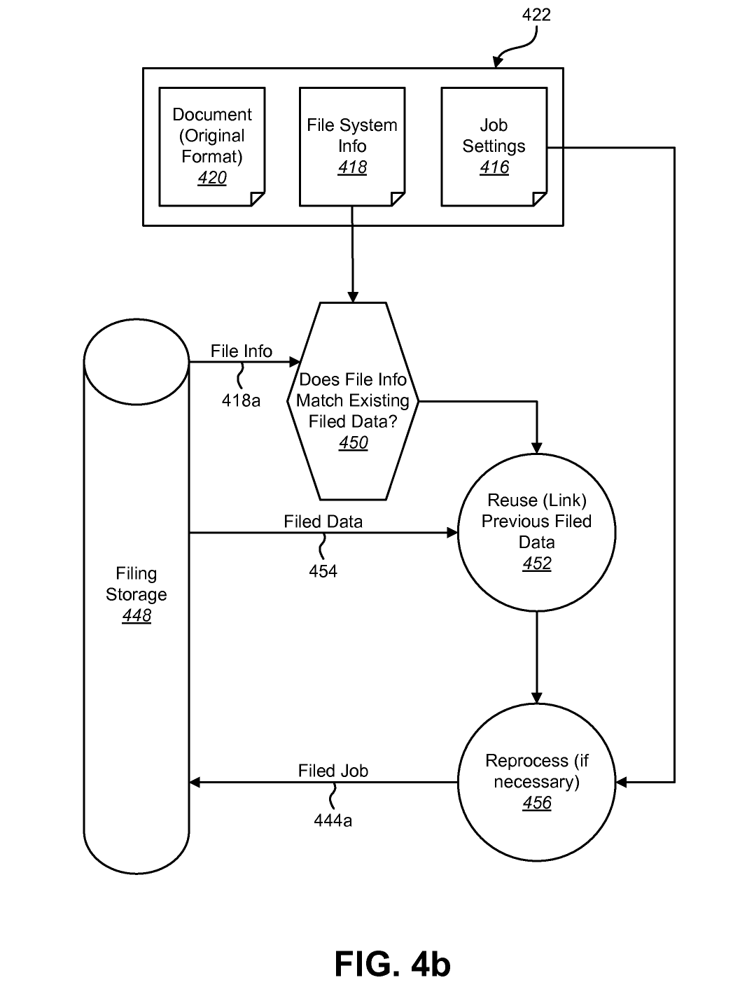

FIGS. 4a and 4b describe the present systems and methods when the MFP 102 supports a filing function that keeps a copy of the rasterized data for some period of time for subsequent reuse (e.g., reprint).

FIG. 4a illustrates when the MFP 102 receives a document 420 or job package 422 for the first time. The MFP 102 may perform the following steps relating to a filing function of the original document 420. The MFP 102 may convert 440 the document 420, if necessary, into printer ready data 442 (i.e., format translation 440). Examples of printer ready data 442 include Postscript, PCL, PDF, TIFF, XPS, etc. The format conversion 440 or translation 440 may convert a document from an original or native format (e.g., Microsoft Word, HTML, etc.) into printer ready data 442 (e.g., Postscript, PCL, PDF, TIFF, XPS, etc.).

The printer ready data 442 is rasterized into engine ready data 444 by a raster image processor (RIP) 446. The RIP 446 may be a component used in the MFP 102 or printing device 102 to produce a bitmap. The bitmap may then be used by the printing device 102 to output the print job 422. The engine ready data 444 is a bitmap generated by the RIP 446.

The rasterized data 444 or engine ready data 444 may be stored in a filing repository 448. The filing repository 448 may be internal to the device 102, external or in removable storage. Additionally, the filing repository 448 may store the file system information 418 associated with the document 420.

FIG. 4b illustrates when the MFP 102 receives a document 420 or job package 422 after having received it at least once before. When the MFP 102 subsequently receives documents 420 relating to a filing function, the MFP 102 first attempts to determine 450 if the document 420 has been seen before and if so, whether the contents of the document 420 are unchanged (as described earlier).

If the MFP 102 determines 450 that the document 420 has been processed before (i.e., rasterized data 444 is still in filing storage 448), without changes to content, the MFP 102 performs the same filing function as described above, with the following exception:

1. The MFP 102 may skip the step of translating the document, if necessary, into printer ready data.

2. The MFP 102 may skip the step of rasterizing the printer ready data into engine ready data or rasterized data.

3. The MFP 102 may use 452 a link (or optional copy of) to the previously stored filed data 454.

4. The previously stored (matching) file data 454 may maintain a link count. If the associated previously filed data entry is deleted and the link count is not zero, the filed data is preserved until the link count is zero.

If necessary, the MFP 102 may reprocess 456 the document 420 or package 422. After reprocessing 456, the MFP 102 may store the newly generated engine ready data 444a or rasterized data 444a.

The present systems and methods may be used to preserve and reuse raster data, even when the user does not explicitly request to file the raster data. The MFP 102 may be instructed (e.g., administrative setting) to temporarily preserve the raster data of any job where a document is rasterized into engine ready data. The preserved data may be stored internally, externally or on removable storage. Any means may be used to specify the length that the raster data is temporarily stored, such as: a fixed time interval, manual deletion, or lack of storage space. The MFP 102 would then perform the same process for a temporary filing as described above for an explicit filing job.

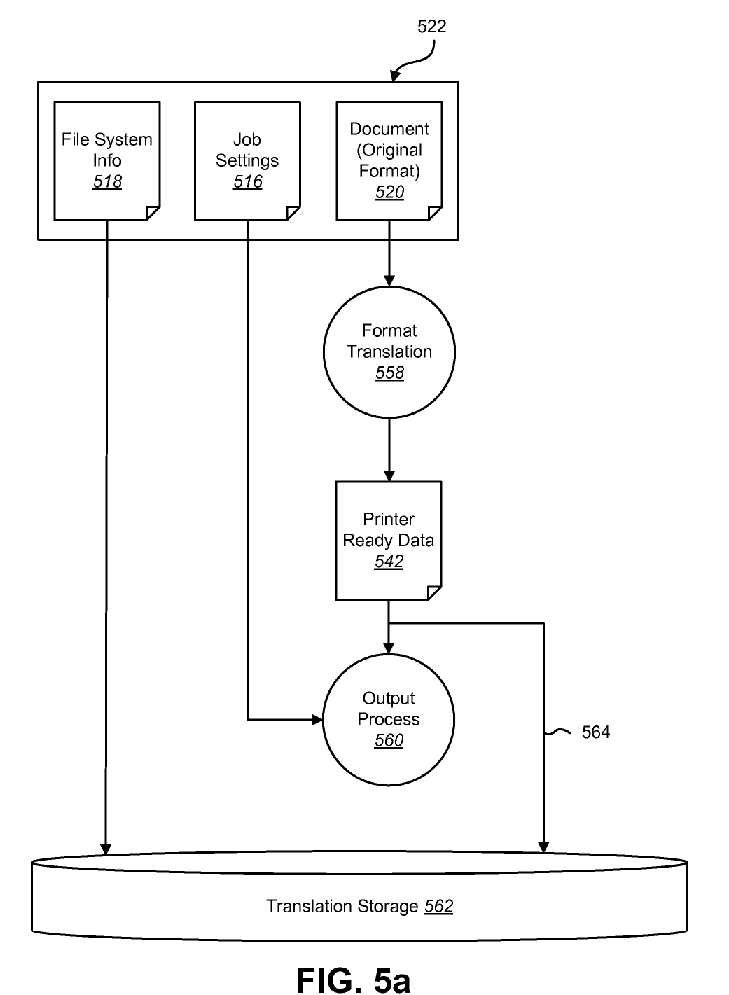

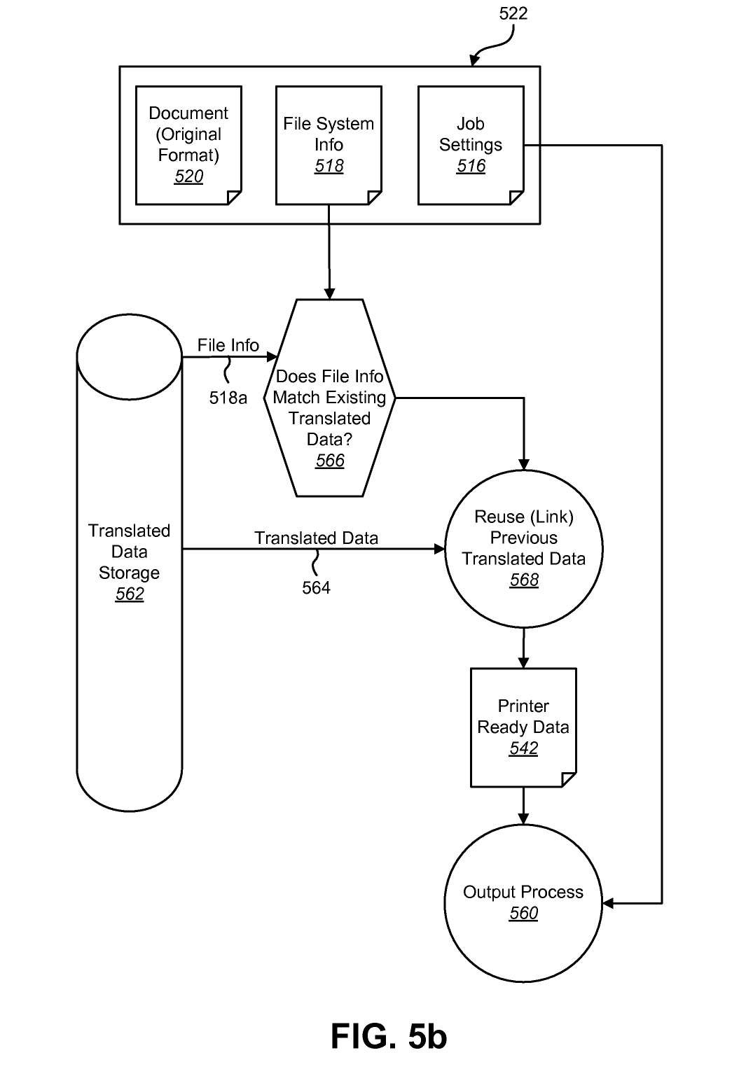

FIG. 5a illustrates when the MFP 102 supports a format translation function, either internally or using an external service. When the MFP 102 receives a document for a first time, the MFP 102 may perform the following steps relating to a format translation function of the original document, when the document is not in a format native to the MFP 102.

The MFP 102 may convert 558 the document, if necessary, into printer ready data 542 (i.e., format translation). Additionally, the MFP 102 temporarily stores the translated data 564 in a translation data repository 562. The translation repository 562 may be internal to the device, external or in removable storage. Additionally, the translation storage repository 562 stores the file system information 518 associated with the document 520.

FIG. 5b illustrates a subsequent format translation. When the MFP 102 subsequently receives documents relating to a format translation function, the MFP 102 first attempts to determine 566 if the document 520 has been seen before and if so, the contents of the document are unchanged (as described earlier).

If the MFP 102 determines that the document 520 has been processed before (i.e., translated data 564 is still in translation storage 562), without changes to content, the MFP 102 may perform the same format translation function as described above, with the following exception:

1. The MFP 102 may skip the step of translating 558 the document, if necessary, into printer ready data 542.

2. The MFP 102 may use 568 a link (or optional copy of) to the previously stored translated data 564. The previously stored translated data 564 (printer ready data 542) is then provided to an output process 560. The output process 560 may use the job settings 516 from the job package 522.

The present systems and methods may also be used with an MFP 102 supporting an accounting function that charges per imaging step. When the MFP 102 receives a document for the first time, the MFP 102 may perform the following steps relating to a job accounting function associated with the job and document:

1. If the document is translated into printer ready data, a cost or ‘a measurement of work’ is charged to the corresponding account (e.g., user, department), which is specific to this function.

2. If the document is rasterized into engine ready data, a cost or ‘a measurement of work’ is charged to the corresponding account (e.g., user, department), which is specific to this function.

3. If the document is outputted, a cost or ‘a measurement of work’ is charged to the corresponding account (e.g., user, department), which is specific to this function.

A later or subsequent job may be treated in the following way. When the MFP 102 subsequently receives documents relating to a job accounting function, the MFP 102 may first attempt to determine if the document has been seen before and if so, the contents of the document are unchanged (as described earlier).

If the MFP 102 determines that the document has been processed before, without changes to content, the MFP 102 may perform the same accounting function as described above, with the following exception:

1. If the MFP 102 reuses translated data, the account may either not be charged or may receive a reduced charge for the translation function.

2. If the MFP 102 reuses rasterized data, the account may either not be charged or may receive a reduced charge for the rasterization function.

Other configurations may also benefit from the present systems and methods. For example, natural language translation may benefit from the systems and methods herein.

The various configurations provide different features that may be used. For example, one feature that may be realized is that the system may automatically and without user knowledge or direction store the data that may be reused. Thus, various configurations of the present systems and methods may not require the user to explicitly indicate the store of the translated data or the rasterized data. In contrast, the present systems and methods may provide an intelligent system to recognize that the data is already stored, based on file system information. Thus, the user does not need to know that it is stored and that the document contents have not changed.

Another feature is that the present systems and methods may automatically store both the translated and raster formats. This intelligent system recognizes that the data is already stored based on file system information when a user attempts to reprint the same unchanged document.

FIG. 6 is a block diagram illustrating the major hardware components typically utilized with embodiments herein. The systems and methods disclosed may be used with a computing device 602 and a printing device 620. The major hardware components typically utilized in a computing device 602 are illustrated in FIG. 6. A computing device 602 typically includes a processor 603 in electronic communication with input components or devices 604 and/or output components or devices 606. The processor 603 is operably connected to input 604 and/or output devices 606 capable of electronic communication with the processor 603, or, in other words, to devices capable of input and/or output in the form of an electrical signal. Embodiments of devices 602 may include the inputs 604, outputs 606 and the processor 603 within the same physical structure or in separate housings or structures.

The computing device 602 may also include memory 608. The memory 608 may be a separate component from the processor 603, or it may be on-board memory 608 included in the same part as the processor 603. For example, microcontrollers often include a certain amount of on-board memory.

The processor 603 is also in electronic communication with a communication interface 610. The communication interface 610 may be used for communications with other devices 602, printing devices 620, servers, etc. Thus, the communication interfaces 610 of the various devices 602 may be designed to communicate with each other to send signals or messages between the computing devices 602.

The computing device 602 may also include other communication ports 612. In addition, other components 614 may also be included in the computing device 602.

Many kinds of different devices may be used with embodiments herein. The computing device 602 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 6 is only meant to illustrate typical components of a computing device 602 and is not meant to limit the scope of embodiments disclosed herein.

The computing device 602 is in electronic communication with the printing device 620. A printing device 620 is a device that receives or transmits an imaging job, such as a Multi-Function Peripheral (“MFP”) or computing device. Printing devices include, but are not limited to, physical printers, multi-functional peripherals, a printer pool, a printer cluster, a fax machine, a plotter, a scanner, a copier, a logical device, a computer monitor, a file, an electronic whiteboard, a document server, a filing device, display device, audio/visual recorder/player, a media duplication device, etc. A typical printing device, such as a physical printer, fax machine, scanner, multi-functional peripheral or copier is a type of computing device. As a result, it also includes a processor, memory, communications interface, etc., as shown and illustrated in relation to the computing device 602. The printing device may be a single or a plural grouping (e.g., pool or cluster) of two or more devices.

FIG. 7 is a network block diagram illustrating one possible environment in which the present systems and methods may be implemented. The present systems and methods may also be implemented on a standalone computer system. FIG. 7 illustrates a computer network 701 comprising a plurality of computing devices 702, a printing device 720 and a print server 724.

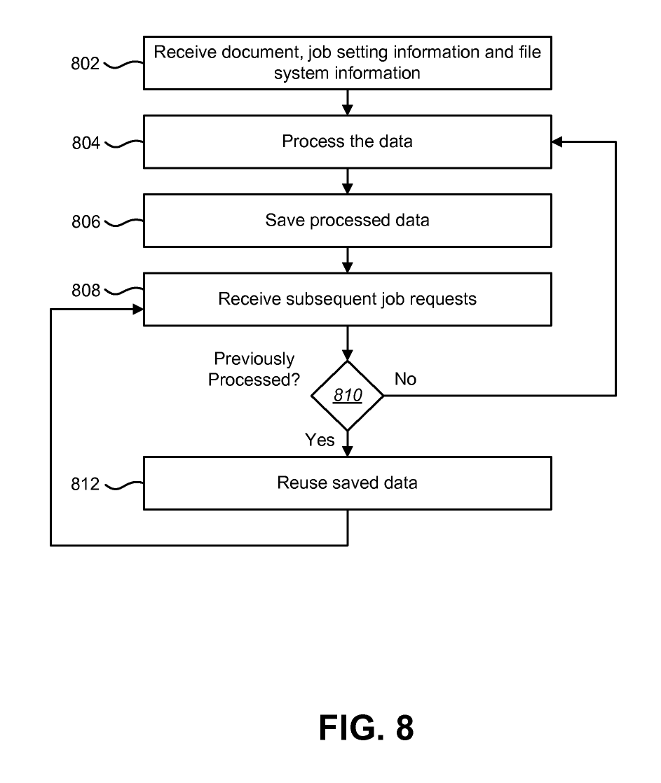

FIG. 8 illustrates one configuration of a method for reusing processed data in an imaging device. In the configuration shown in FIG. 8, a document 106, job setting information and file system information are received 802 by an imaging device without conversion into printer ready data (i.e., driverless). The MFP 102 processes 804 the data to produce processed data. The processed data may be rasterized data, translated data, auditing data, etc. This processed data may be saved 806 by the MFP for some period of time. Additionally, the file system info of the original document is saved with the saved data.

When the MFP 102 receives 808 subsequent job requests, it first determines 810 if the same document had been previously processed by comparing file system information of the saved data with the file system information of the subsequent job request. If it is the same data, the MFP and/or external services may skip the processing step and reuse 812 the saved data, after which it may receiver 808 additional job requests. If it is not the same data, the MFP and/or external services may process 804 the job, and continue as outlined above.

By reusing the saved data, the MFP 102 becomes more efficient in being able to use less processing power and output faster on documents which are frequently processed. The less use of translation/rasterization services may also reduce per job costs. Additionally, reuse of thinned document data in an audit trail may reduce the amount of needed storage.

Through the above and other reductions realized, an owner/lessee of an imaging device or MFP 102 may realize a reduction in the total cost of ownership (TCO).

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules, circuits and algorithm steps described in connection with the embodiments disclosed herein may be implemented as electronic hardware, computer software or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limiting the scope of the claims.

The various illustrative logical blocks, modules and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the embodiments disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

While specific embodiments have been illustrated and described, it is to be understood that the claims are not limited to the precise configuration and components illustrated above. Various modifications, changes and variations may be made in the arrangement, operation and details of the embodiments described above without departing from the scope of the claims.

What is claimed is:

1. A method for reusing data in an imaging device, the method comprising:
receiving an imaging job at an imaging device, wherein the imaging job includes file system information and a document in a first format;
determining whether the document has been previously processed by the imaging device;
processing the document if it was determined that the document had not been previously processed by the imaging device, wherein the processing provides a processed document in a second format;
saving the processed document if it was determined that the document had not been previously processed by the imaging device; and
reusing a previously saved processed document that corresponds to the document if it was determined that the document had been previously processed by the imaging device.

2. The method of claim 1, wherein processing the document comprises translating the document, and wherein the second format comprises printer ready data.

3. The method of claim 1, wherein processing the document comprises rasterizing the document, and wherein the second format comprises engine ready data.

4. The method of claim 1, wherein processing the document comprises thinning the document, and wherein the second format comprises a thinned document.

5. The method of claim 1, wherein determining comprises comparing the file system information with saved file system information.

6. The method of claim 5, wherein the file system information includes a pathname, a file size, a modification date and an author.

7. The method of claim 6, wherein the file system information further includes a checksum and a universally unique identifier (UUID).

8. The method of claim 1, wherein the imaging device comprises a multi-function peripheral.

9. The method of claim 1, wherein the first format is not printer ready data such that the document was sent to the imaging device using a direct submit utility, and wherein processing the document comprises translating the document, and wherein the second format comprises printer ready data, and wherein the method further comprises second processing, wherein the second processing comprises rasterizing the printer ready data into engine ready data.

10. The method of claim 1, wherein saving further comprises saving the file system information with the processed document.

11. The method of claim 1, wherein determining is accomplished automatically and without user input regarding determining whether the document has been previously processed by the imaging device.

12. The method of claim 1, wherein the imaging job further includes job settings.

13. The method of claim 1, wherein the imaging job comprises a print job.

14. An imaging device that is configured for reusing data, the imaging device comprising:
a processor;
memory in electronic communication with the processor; and
instructions stored in the memory, the instructions being executable to:
receive an imaging job at an imaging device, wherein the imaging job includes file system information and a document in a first format;
determine whether the document has been previously processed by the imaging device;
process the document if it was determined that the document had not been previously processed by the imaging device, wherein the processing provides a processed document in a second format;
save the processed document if it was determined that the document had not been previously processed by the imaging device; and
reuse a previously saved processed document that corresponds to the document if it was determined that the document had been previously processed by the imaging device.

15. The imaging device of claim 14, wherein processing the document comprises translating the document, and wherein the second format comprises printer ready data.

16. The imaging device of claim 14, wherein processing the document comprises rasterizing the document, and wherein the second format comprises engine ready data.

17. The imaging device of claim 14, wherein processing the document comprises thinning the document, and wherein the second format comprises a thinned document.

18. The imaging device of claim 14, wherein determining comprises comparing the file system information with saved file system information.

19. The imaging device of claim 18, wherein the file system information includes a pathname, a file size, a modification date and an author.

20. The imaging device of claim 19, wherein the file system information further includes a checksum and a universally unique identifier (UUID).

21. The imaging device of claim 14, wherein the imaging device is a multi-function peripheral imaging device.

22. The imaging device of claim 14, wherein the first format is not printer ready data such that the document was sent to the imaging device using a direct submit utility, and wherein processing the document comprises translating the document, and wherein the second format comprises printer ready data, and wherein the method further comprises second processing, wherein the second processing comprises rasterizing the printer ready data into engine ready data.

23. The imaging device of claim 14, wherein saving further comprises saving the file system information with the processed document.

24. The imaging device of claim 14, wherein determining is accomplished automatically and without user input regarding determining whether the document has been previously processed by the imaging device.

25. The imaging device of claim 14, wherein the imaging job further includes job settings.

26. The imaging device of claim 14, wherein the imaging job comprises a print job.

27. A computer-readable medium comprising executable instructions for:
receiving an imaging job at an imaging device, wherein the imaging job includes file system information and a document in a first format;
determining whether the document has been previously processed by the imaging device;
processing the document if it was determined that the document had not been previously processed by the imaging device, wherein the processing provides a processed document in a second format;
saving the processed document if it was determined that the document had not been previously processed by the imaging device; and
reusing a previously saved processed document that corresponds to the document if it was determined that the document had been previously processed by the imaging device.
